(19) United States
(12) Patent Application Publication
(10) Pub. No.: US 2005/0181115 A1
(43) Pub. Date: Aug. 18, 2005

(54) Method and apparatus for continuously producing a confectionery mass

(75) Inventors: Klaus Markwardt, Laatzen (DE); Jens Fleisch, Wernigerode (DE); Zvonimir Versic, Hannover (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: CHOCOTECH GmbH

(21) Appl. No.: 11/053,605

(22) Filed: Feb. 8, 2005

(30) Foreign Application Priority Data
Feb. 12, 2004 (DE) 10 2004 006859.3

(51) Int. Cl. A23G 3/00

(52) U.S. Cl. 426/660

(57) ABSTRACT

A method and an apparatus serve to continuously produce a confectionery mass from an aqueous solution of ingredients. The aqueous solution is boiled and evaporated to produce a mass. The mass is subjected to negative pressure, and ingredients in the form of powder and/or crystals are sucked into the mass due to the negative pressure.

### CROSS REFERENCE TO RELATED APPLICATIONS

This application claims priority to co-pending German Patent Application No. DE 10 2004 006 859.3 entitled “Verfahren und Vorrichtung zur kontinuierlichen Herstellung von Süβwarenmasse”, filed Feb. 12, 2004.

### FIELD OF THE INVENTION

The present invention generally relates to a method and an apparatus for continuously producing a confectionery mass. Especially, the present invention relates to a method and an apparatus in which the mass is produced from a aqueous solution of ingredients. The solution is boiled, evaporated, put under negative pressure and discharged. Flavors, colors and other ingredients may be introduced into the mass and mixed with the mass after boiling.

### BACKGROUND OF THE INVENTION

A method for continuously producing hard candy masses from an aqueous solution of ingredients is known from European Patent Application No. EP 0 348 696 A2 corresponding to U.S. Pat. No. 5,167,981. The ingredients being dissolved are boiled, evaporated, put under negative pressure, discharged and mixed with other ingredients to finally form a candy mass. Sugar substitute substances are used as ingredients. The heating apparatus for boiling the aqueous solution of ingredients is operated under negative pressure which comes from the evaporating chamber. The negative pressure reaches the heating apparatus such that it also prevails in the heating apparatus. The introduction of flavors and other ingredients stored in containers is realized by apportioning pumps and conduits connected thereto, the conduits extending into the housing of the mixing apparatus located downstream of the discharging apparatus. The ingredients are introduced in liquid form to be mixed with the mass in the mixing apparatus.

A method and an apparatus for continuously producing hard sugar masses and the like are known from European Patent Application No. EP 0 054 960 A1 corresponding to U.S. Pat. No. 4,487,118. After boiling, the mass is freed from water by treatment under negative pressure. The known apparatus includes an evaporating chamber being connected to a vacuum pump and being located downstream of the heating apparatus. The apparatus further includes a mixing and discharging apparatus for the sugar mass to be further processed. A plurality of vacuum chambers is located one after the other. The discharging apparatus and the mixer are combined to form a common unit. Additional ingredients, such as flavors, colors, acids and the like in liquid form or in crystal form are introduced into the housing of the mixing apparatus, and they are uniformly distributed in the mass contained in the mixing apparatus.

German Patent No. DE 1 283 662 B relates to a method of continuously producing fondant masses with a heating apparatus for boiling the dissolved ingredients. A first evaporating chamber and a second evaporating chamber are located downstream of the heating apparatus. A cooling and beating unit is connected to these chambers. This unit can also fulfill the function of discharging and mixing the mass. Ingredients for this fondant mass, as for example milk, colors, flavors, and the like, are introduced into the mixing apparatus via a funnel-like inlet located downstream of the beating unit. This introduction is realized by the opened funnel such that air may contact the mass, and air is being introduced into the mass.

It is known generally known in the art to introduce ingredients in the form of powder and/or crystals into a mixing apparatus via an opened funnel by scattering or sprinkling. Such ingredients, especially acid, are not introduced in the form of a liquid solution, but rather as powder and as solid material, respectively. Consequently, air enters the mass, which is very disadvantageous for certain ingredients. Especially, this is a problem with sugar substitute substances. Thus, the confectionery mass contains air in the form of bubbles. These bubbles may be undesirable for various reasons. On the one hand, they have a negative influence on further processing the mass to attain the final product. Additionally, they have a negative impact on the appearance of the product and on consumption of the product.

It is also known generally in the art to introduce ingredients of different shapes into a mass. Some ingredients are introduced as dissolved substances which can be pumped through conduits. Other ingredients in the form of powders or crystals are introduced by scattering or sprinkling, as this has been described above. Due to the funnel and the connection to the ambient air required for this purpose, there is the problem of the other ingredients which have been introduced in the form of a liquid solution at least partly evaporating and exiting through the opened funnel.

It is also generally known in the art that certain types of ingredients, especially acid types, tend to stick to an opened funnel of a mixing apparatus. These materials are partly hygroscopic, and they tend to stick to the funnel such that there may be an accumulation of these materials at this place, which may cause the funnel to be closed. These effects have a negative impact on the continuous production. Due to the fact that the ingredients have to be introduced in the region of the mixing apparatus, the mixing apparatus has to convey more mass than the discharging apparatus to ensure that the funnel being located at the mixing apparatus remains clear to be able to introduce crystalline acid, for example, by gravity. This also means that it is possible that the pressure increases in the discharging apparatus and in the mixing apparatus located downstream since there is connection to the atmosphere via the funnel. Consequently, the mixing apparatus has to be operated with a certain number of revolutions to convey the confectionery mass and to make sure that the funnel stays clear. This required number of revolutions makes it more difficult to carefully treat the confectionery mass in the mixing apparatus, especially in the case of sensitive masses. In case it is desired that the pressure increases in a mixing apparatus including an opened funnel, a pressure maintaining valve needs to be arranged at the exit of the mixing apparatus. T he entire increase of pressure has to be realized in the mixing apparatus. For example, this is the case if gaseous substances, especially air, are introduced into the mixing apparatus and if the mixing apparatus thus also fulfills the beating function.

### SUMMARY OF THE INVENTION

The present invention relates to a method of continuously producing a confectionery mass from an aqueous solution of ingredients. The method includes the steps of boiling the solution, evaporating the solution to produce a mass, putting the mass under the influence of negative pressure, introducing ingredients selected from the group consisting of powders and crystals under the influence of negative pressure into the mass in a way that the ingredients are sucked into the mass, and discharging the mass.

The present invention also relates to an apparatus for continuously producing a confectionery mass from an aqueous solution of ingredients. The apparatus includes a heating apparatus for boiling the aqueous solution of ingredients. At least one chamber is located downstream of the heating apparatus. The chamber serves to subject the solution to a process selected from the group consisting of evaporating and vacuumizing to attain a mass. The chamber is under the influence of negative pressure. At least one introducing unit is connected to the chamber. The introducing unit serves to introduce ingredients selected from the group consisting of powders and crystals into the mass in the chamber. A discharging apparatus serves to discharge the mass from the chamber. A mixing apparatus serves to mix the mass.

The present invention relates to the introduction of ingredients in the form of powder and/or crystals, for example acid, during the production of a confectionery mass. These ingredients have to be introduced into the mass, and it is desired to uniformly distribute them in the mass to make sure that they are uniformly distributed in the finished confectionery product. The confectionery mass may especially be one including sugar or sugar substitute substances. Confectionery masses including sugar usually are less susceptible to the introduction of atmospheric oxygen. Sugar substitute substances have varying properties in this respect. There are sugar substitute substances which are extremely susceptible to air and to the introduction of atmospheric oxygen. This especially applies to air bubbles being incorporated into the mass in the mixing apparatus in an undesired way.

With the novel method and apparatus for continuously producing a confectionery mass, it is possible to introduce ingredients in the form of powder and/or crystals, especially acids, into the confectionery mass without introducing air, and to evenly mix these ingredients with the mass.

In the novel method for continuously producing a confectionery mass, ingredients in the form of a powder or crystals are sucked into the mass under the influence of negative pressure. This especially applies to the introduction of acids as solid material. The negative pressure (or vacuum) fulfills a conveying function, and it prevents sticking of these ingredients to components of the introducing apparatus.

It is possible to still use known apportioning introducing apparatuses, as they are used in the art for simply introducing such ingredients under the influence of gravity. The novel introduction of these ingredients into a chamber under the influence of negative pressure also provides for the advantage of the air coming through the opened connection to the atmosphere and being sucked in being removed by the source of negative pressure, while the introduced ingredients remain in the mass. The introduction of these ingredients may take place at a comparatively early step in the production process. A chamber already available may be used for the introduction. The chamber is under the influence of negative pressure, and it may be used to evaporate and/or cool the mass, for example.

It is also possible to use an additional vacuum chamber to realize the introduction of the ingredients in the form of a powder and/or crystals. Usually, these steps take place upstream of the discharging apparatus and of the following mixing apparatus. In this way, the vacuum chamber is used for removal of the air being introduced through the opening to the atmosphere, on the one hand. On the other hand, there is the possibility of operating the apparatus in a closed way (meaning without the introduction of air) in following processing steps, for example in the discharging apparatus and in the mixing apparatus. This allows for the production of a confectionery product having no bubbles.

However, in case it is desired to produce a confectionery product including air, it is possible to realize the desired introduction of air in a controlled way through the closed discharging apparatus and/or the mixing apparatus located downstream. In this way, the aeration level of the mass may be better adjusted and maintained with increased exactness compared to a usual funnel allowing for a connection to the atmosphere. In case a vacuum chamber and/or an evaporating chamber under the influence of negative pressure is used to introduce the ingredients in the form of powder and/or crystals, the source of negative pressure is chosen to have greater dimensions and/or it is adjusted in a way that the required vacuum is maintained in the chamber despite the opened connection to the atmosphere.

The apparatus which may be used to conduct the novel method includes a unit for introducing ingredients in the form of powder and/or crystals. The unit is connected to a chamber which is under the influence of negative pressure. It is preferred to design the discharging apparatus and the mixing apparatus to be closed (meaning not to be connected to the atmosphere). It is to be understood that the discharging apparatus however includes an entrance and an exit for conveying the mass through it. The same applies to the mixing apparatus. The “closed” design relates to the prevention of another opening, as it is known from the prior art in which this opening is connected to a funnel.

With the novel apparatus, the introduction of the ingredients upstream of the discharging apparatus allows for particularly uniform distribution of the ingredients in the mass since the discharging apparatus is also used to incorporate and distribute the ingredients. It is to be understood that usually different ingredients are introduced of which at least one substance is a powder and/or is designed in the form of crystals. Usually, liquid ingredients are also introduced into the solution. This may be realized in a known way by apportioning pumps and closed conduits which make sure that no air is introduced.

It is especially preferred if the unit for introducing ingredients in the form of powder and/or crystals is connected to a vacuum chamber being located below an evaporating chamber and being connected thereto. The vacuum chamber is connected to a source of negative pressure being designed and arranged to maintain the required vacuum despite the opened trim located at the unit for introducing ingredients in the form of powder and/or crystals. In this way, a place in the production process is used which results in earlier introduction of these ingredients during manufacture. For example, it is possible to realize the introduction below a mass level in the respective vacuum chamber such that introduced air is effectively removed, and the ingredients are directly introduced into the mass to be uniformly distributed in the mass.

Due to the avoidance of an opened funnel being located at the mixing apparatus, there is the possibility of arranging a pressure maintaining valve at the exit of the mixing apparatus such that positive pressure may build up in the discharging apparatus and the mixing apparatus being located directly downstream thereof. The mixing apparatus may be completely filled with confectionery mass, and it may be operated at a low number of revolutions in an advantageous way. This results in careful treatment of the mass.

In a preferred embodiment of the novel apparatus, and evaporating chamber and a vacuum chamber are located downstream of the boiling apparatus. The discharging apparatus is arranged at the lower end of the vacuum chamber. The discharging apparatus may have various designs. The mixing apparatus is arranged downstream of the discharging apparatus. The unit for introducing ingredients in the form of powder and/or crystals may include an introduction tube which protrudes into the vacuum chamber, and which ends close to the region between the vacuum chamber and the discharging apparatus. In this way, the introduction may take place at the exit of the vacuum chamber and at the entrance into the discharging chamber, respectively, such that direct incorporation of the ingredients is ensured. However, it is also possible to connect the unit for introducing the ingredients to the evaporating chamber, meaning even earlier in the production process. It is also possible to realize evaporation and treatment with negative pressure in one common evaporating and vacuum chamber.

Due to the avoidance of an opened funnel located at the mixing apparatus and due to the fact that the ingredients in the form of powder and/or crystals are introduced into a chamber which is under the influence of negative pressure, there are a number of advantages. The system for discharging and mixing the mass located downstream may be designed to be closed. This means that no air is introduced into the mass in an undesired way. The losses of ingredients occurring during evaporation and/or exiting through the funnel-shaped trim are substantially reduced. Conveying of the mass in the region of the discharging apparatus and of the mixing apparatus may be ensured and supported by units being located upstream. Consequently, the mixing apparatus may be operated at a reduced number of revolutions to carefully treat the mass. The discharging apparatus and the mixing apparatus located downstream thereof may be operated at positive pressure in case a pressure maintaining valve is arranged at the exit of the mixing apparatus. It is preferred to use this embodiment when gaseous ingredients are to be mixed with the mass.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a schematic view of components of a first exemplary embodiment of the novel apparatus for continuously producing a confectionery mass.

FIG. 2 is a view of a part of FIG. 1 of a second exemplary embodiment of the novel apparatus.

FIG. 3 is a view of a part of FIG. 1 of a third exemplary embodiment of the novel apparatus.

### DETAILED DESCRIPTION

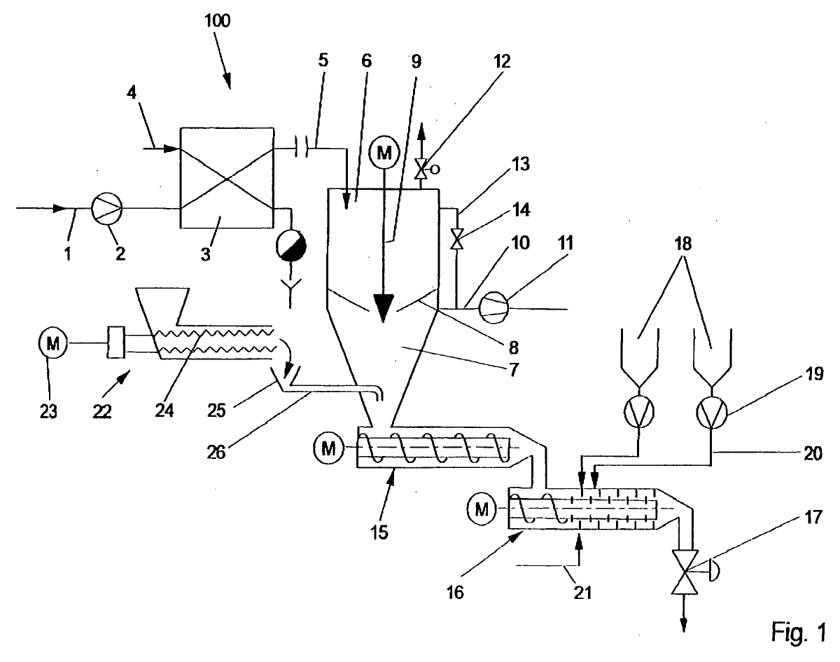

Referring now in greater detail to the drawings, FIG. 1 illustrates elements and components of an exemplary embodiment of the novel apparatus 100 for conducting a novel method of continuously producing a confectionery mass from an aqueous solution of ingredients. Some of the ingredients for the confectionery mass are dissolved in water to attain the aqueous solution. For example, the ingredients may include sugar, sugar substitute substances, glucose syrup and the like. The dissolved ingredients contained in an apparatus for weighing and apportioning (not illustrated) are pumped by a pump 2 through a conduit 1 to reach a heating apparatus 3. The heating apparatus 3 may be designed as a spiral cooking apparatus and the like. For example, the heating apparatus 3 is heated by steam being delivered by a conduit 4. The heat is transmitted to the solution of ingredients by condensation of the steam on the spiral of the heating apparatus 3.

An evaporating chamber 6 is arranged downstream of the heating apparatus 3 and of a connecting conduit 5. The solution is to evaporate in the evaporating chamber 6. The evaporated water of the solution is received as exhaust vapor in the evaporating chamber 6.

A vacuum chamber 7 is located downstream of the evaporating chamber 6. In the illustrated embodiment, the evaporating chamber 6 and the vacuum chamber 7 are located in one common tank or housing having a vertical axis. An intermediate bottom 8 including a needle valve 9 being driven by a motor allows for the mass moving from the evaporating chamber 6 into the vacuum chamber 7. The vacuum chamber 7 is connected to a source of negative pressure 11 by a conduit 10. The source of negative pressure 11 may be designed as a vacuum pump, and it serves to supply the required negative pressure in the vacuum chamber 7. The evaporating chamber 6 may include an exhaust vapor valve 12 for removal of the exhaust vapors. The evaporating chamber 6 may be connected to the conduit 10 and, consequently, to the source of negative pressure 11 via a conduit 13. A locking valve 14 is located in the conduit 13. It is to be understood that the locking valve 14 is closed when the exhaust vapors are removed via the exhaust vapor valve 12.

A discharging apparatus 15 is arranged at the lower end of the vacuum chamber 7. The discharging apparatus 15 includes a housing and a conveying screw being driven by a motor. The housing is connected to the vacuum chamber 7 in a sealed way such that the mass may flow into the discharging apparatus 15 at this place.

The discharging apparatus 15 leads to a mixing apparatus 16 which may especially be designed as a conveying screw located in a housing and being driven by a motor. The discharging apparatus 15 and the mixing apparatus 16 may also be located in one common housing adjacent to one another, or they may also be designed to form one common structural unit. The shaft of the conveying screw may include mixing elements, conveying elements, beating elements and the like, as it is required by the respective mass to be processed.

A pressure maintaining valve 17 is arranged at the exit of the mixing apparatus 16. Liquid ingredients such as colors, flavors and the like are introduced by containers 18, apportioning pumps 19 and conduits 20. They are introduced into the mixing apparatus 16 and into the mass contained therein, respectively. The conduits 20 are connected to the housing of the mixing apparatus 16 such that no ambient air is introduced at this place. In case it is desired to introduce a gaseous substance into the mass such as, for example, air, nitrogen and the like, the introduction is realized via a conduit 21 being connected to the mixing apparatus 16.

The apparatus 100 further includes an introducing unit 22 being designed and arranged to introduce ingredients in the form of powder and/or crystals. The introducing unit 22 may include an apportioning screw 24 being driven by a motor 23. The material in the form of powder and/or crystals is introduced into a funnel 25 after going though a freefall. A tube 26 is connected to the funnel 25, the tube 26 extending through the wall of the tank of the vacuum chamber 7 to reach the interior of the vacuum chamber 7. The tube 26 especially ends in the lower portion of the vacuum chamber 7 close to the entrance into the discharging apparatus 15. However, it may also be arranged at a different location.

The unit 22 is connected to the ambient air in the region of the funnel 25 and/or at a different location such that the negative pressure prevailing in the vacuum chamber 7 does not only suck in the ingredients in the form of powder and/or crystals, but also some ambient air. The ambient air allows for unobstructed conveying of the ingredients towards the mass. The ambient does not have a negative effect since the negative pressure in the vacuum chamber 7 is adjusted by the source of negative pressure 11 such that the air sucked in via the unit 22 is removed and does not remain in the mass. Air bubbles being located in the mass in the region of the vacuum chamber 7 are removed by the negative pressure such that a mass having no bubbles it discharged via the discharging apparatus 15. It then reaches the mixing apparatus 16 and possibly other elements to be further processed.

It is to be seen from FIG. 1 that the housings of the discharging apparatus 15 and of the mixing apparatus 16 may be designed to be closed, meaning not to be directly connected to the ambient air (with the exception of the tube 26). This design provides for a plurality of advantages. Other ingredients being introduced in a liquid form cannot evaporate or volatilize. They remain in the mass and in the confectionery product to be produced from the mass.

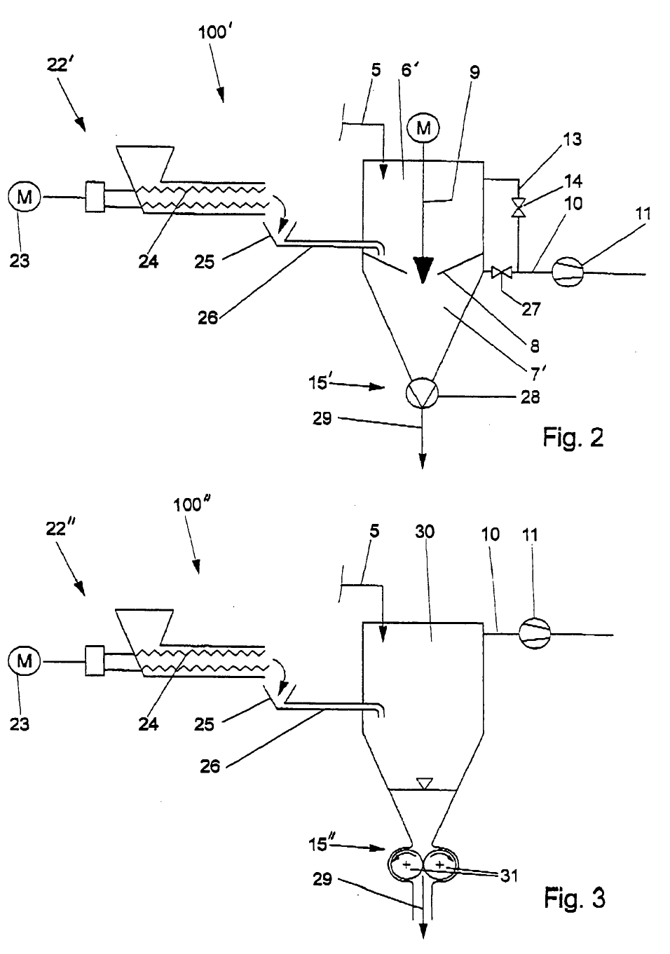

The exemplary embodiment of the novel apparatus 100′ illustrated in FIG. 2 has a lot in common with the apparatus 100 illustrated in FIG. 1. Consequently, it is referred to the above description. FIG. 2 substantially illustrates the differing components of the apparatus 100′ compared to the apparatus 100 illustrated in FIG. 1. The evaporating chamber 6′ does not include an exhaust vapor exit, but it is connected to the source of negative pressure 11 by the conduit 13. A pressure of approximately 0.1 bar absolute may be adjusted in the evaporating chamber 6′, while a pressure of approximately 0.05 bar absolute is produced in the vacuum chamber 7′. The valves 14 and 27 serve for this purpose.

The unit 22′ is connected to the evaporating chamber 6′ in which a respective negative pressure prevails. The discharging apparatus 15′ is arranged at the lower end of the tank including the evaporating chamber 6′ and the vacuum chamber 7′. The discharging apparatus 15′ is designed as a pump 28. A conduit 29 connects the pump 28 to the mixing apparatus 16 (not illustrated, see FIG. 1). The liquid ingredients are introduced in the region of the mixing apparatus 16, as this has been described with respect to the embodiment of the novel apparatus 100 illustrated in FIG. 1.

From a combination of FIGS. 1 and 2, it is easily imaginable that it is also possible to arrange a plurality of units 22 and 22′, respectively, which may be connected to one common chamber or to a plurality of chambers in which negative pressure prevails, for example the evaporating chamber 6′ and/or the vacuum chamber 7′.

In the exemplary embodiment of the novel apparatus 100″illustrated in FIG. 3, the evaporating chamber 6″ and the vacuum chamber 7″ are combined to form one common evaporating and vacuum chamber 30 being connected to the source of negative pressure 11. The discharging apparatus 15″ is connected to the lower end of the evaporating and vacuum chamber 30. In this case, the discharging apparatus 15″ is designed to include two rollers 31. The conduit 29 leads from the discharging apparatus 15″ to the mixing apparatus 16 (not illustrated). With respect to other elements of the apparatus 100″, it is referred to the above description of FIG. 1. It is to be understood that the remaining components of the apparatuses 100′ and 100″ may have the same design and arrangement as the ones of apparatus 100 illustrated in FIG. 1, or also different designs. It is also to be understood that it is possible to combine features of the apparatuses 100, 100′ and 100″.

Many variations and modifications may be made to the preferred embodiments of the invention without departing substantially from the spirit and principles of the invention. All such modifications and variations are intended to be included herein within the scope of the present invention, as defined by the following claims.

1. A method of continuously producing a confectionery mass from an aqueous solution of ingredients, said method comprising the steps of:
boiling the solution;
evaporating the solution to produce a mass;
putting the mass under the influence of negative pressure;
introducing ingredients selected from the group consisting of powders and crystals under the influence of negative pressure into the mass in a way that the ingredients are sucked into the mass; and
discharging the mass.

2. The method of claim 1, further comprising the following steps after the step of discharging the mass:
introducing additional ingredients into the mass; and
mixing the additional ingredients with the mass.

3. The method of claim 2, wherein the additional ingredients are selected from the group consisting of flavors and colors.

4. The method of claim 1, wherein the ingredients selected from the group consisting of powders and crystals are sucked into the mass before the step of discharging the mass.

5. The method of claim 4, wherein the ingredients are sucked into a vacuum chamber, the vacuum chamber being under the influence of negative pressure.

6. The method of claim 4, wherein the ingredients are sucked into an evaporating chamber, the evaporating chamber being under the influence of negative pressure.

7. The method of claim 4, wherein the ingredients are sucked into a vacuum and evaporating chamber, the vacuum and evaporating chamber being under the influence of negative pressure.

8. The method of claim 1, wherein the step of discharging the mass takes place in a closed chamber.

9. The method of claim 1, further comprising the following step after the step of discharging the mass:
mixing the mass in a closed chamber.

10. The method of claim 9, further comprising the following step after the step of discharging the mass in a closed chamber:
mixing the mass in a closed chamber.

11. The method of claim 1, wherein the value of the negative pressure is chosen such that air being sucked in with the ingredients selected from the group consisting of powders and crystals is removed.

12. The method of claim 7, wherein the value of the negative pressure in the vacuum and evaporating chamber is chosen such that air being sucked in with the ingredients selected from the group consisting of powders and crystals is removed.

13. An apparatus for continuously producing a confectionery mass from an aqueous solution of ingredients, comprising:
a heating apparatus, said heating apparatus being designed and arranged to boil the aqueous solution of ingredients;
at least one chamber, said chamber being located downstream of said heating apparatus, said chamber being designed and arranged to subject the solution to a process selected from the group consisting of evaporating and vacuumizing to attain a mass, said chamber being designed and arranged to be under the influence of negative pressure;
at least one introducing unit, said unit being connected to said chamber, said introducing unit being designed and arranged to introduce ingredients selected from the group consisting of powders and crystals into the mass in said chamber;
a discharging apparatus, said discharging apparatus being designed and arranged to discharge the mass from said chamber; and
a mixing apparatus, said mixing apparatus being designed and arranged to mix the mass.

14. The apparatus of claim 13, wherein said discharging apparatus and said mixing apparatus are designed to be closed.

15. The apparatus of claim 13, wherein said chamber is designed as a vacuum chamber.

16. The apparatus of claim 15, further comprising:
an evaporating chamber, said evaporating chamber being arranged upstream of and above said vacuum chamber;
a source of negative pressure, said source of negative pressure being designed and arranged to supply vacuum, said source of negative pressure being connected to said vacuum chamber; and
a trim, said trim being connected to said introducing unit and to the atmosphere.

17. The apparatus of claim 13, wherein said chamber is designed as a vacuum chamber.

18. The apparatus of claim 13, wherein said chamber is designed as a combined evaporating and vacuum chamber.

19. The apparatus of claim 13, further comprising a pressure maintaining valve, said pressure maintaining valve being arranged at an exit side of said mixing apparatus, said pressure maintaining valve being designed and arranged to realize positive pressure in said discharging apparatus and in said mixing apparatus.

20. An apparatus for continuously producing a confectionery mass from an aqueous solution of ingredients, comprising:
a heating apparatus, said heating apparatus being designed and arranged to boil the aqueous solution of ingredients;
an evaporating chamber, said evaporating chamber being located downstream of said boiling apparatus, said evaporating chamber being designed and arranged to subject the solution to the process of evaporating to attain a mass, said evaporating chamber being designed and arranged to be under the influence of negative pressure;
a vacuum chamber, said vacuum chamber being located downstream of said evaporating chamber, said vacuum chamber having a lower end, said vacuum chamber being designed and arranged to subject the mass to the process of vacuumizing, said vacuum chamber being designed and arranged to be under the influence of negative pressure;
a discharging apparatus, said discharging apparatus being located downstream of said vacuum chamber and at the lower end of said vacuum chamber, said discharging apparatus being designed and arranged to discharge the mass from said vacuum chamber;
an introducing unit, said introducing unit including an introducing tube, said introducing tube being designed and arranged to protrude into said vacuum chamber and to end close to said discharging apparatus, said introducing unit being designed and arranged to introduce ingredients selected from the group consisting of powders and crystals into the mass in said vacuum chamber due to the negative pressure; and
a mixing apparatus, said mixing apparatus being located downstream of said discharging apparatus, said mixing apparatus being designed and arranged to mix the mass.
